(19) United States
(12) Patent Application Publication
(10) Pub. No.: US 2024/0184609 A1
(43) Pub. Date: Jun. 6, 2024

(54) VIRTUALIZED ENVIRONMENT CLUSTER UTILIZATION

(71) Applicant: International Business Machines Corporation, Armonk, NY (US)

(72) Inventors: Abhishek Malvankar, White Plains, NY (US); Alaa S. Youssef, Valhalla, NY (US); Diana Jeanne Arroyo, Austin, TX (US); Asser Nasreldin Tantawi, Somers, NY (US)

(21) Appl. No.: 18/061,943

(22) Filed: Dec. 5, 2022

(51) Int. Cl. G06F 9/455; G06F 9/48

(52) U.S. Cl. CPC G06F 9/45558; G06F 9/4881; G06F 2009/4557

(57) ABSTRACT

Disclosed embodiments provide techniques for compute job allocation in a virtualized computing environment. A first list of compute jobs that are currently executing in a virtualized environment is obtained. For each job in the first list, a job description file is obtained. An entity extraction process is performed on the job description file to extract a plurality of job entities. Multiple clusters are created that correspond to the compute jobs in the first list. A second list of compute jobs that are currently queued for execution is obtained. Compute jobs in the second list are assigned to a cluster from the plurality of clusters, and the virtualized environment is reused for execution of a compute job from the second list based on the assigned cluster.

### FIELD

The present invention relates generally to computing, and more particularly, to virtualized environment cluster utilization.

### BACKGROUND

A cloud application is software that runs its processing logic and data storage between a client-side and server-side. Some processing takes place on an end user's local hardware, such as a desktop or mobile client device, and some takes place on a remote server. One of the benefits of cloud applications is that most data storage exists on a remote server. Using these techniques, some cloud applications can be configured to use very little storage space on a local device. Client devices interact with a cloud application via a web browser or application programming interface (API).

The cloud servers can be configured to implement a virtualized and/or containerized environment. In a virtualized environment, virtual machines (VMs) include the guest operating system (OS) along with all the code for their applications and application dependencies. VMs abstract servers from the underlying hardware. In a containerized environment, the containers include all the binaries, libraries, and configuration that an application requires. However, containers do not include virtualized hardware or kernel resources. Rather, containers run on a container runtime platform that abstracts the resources. Because containers just include the basic components and dependencies of an app without additional bloat, they are generally faster and more lightweight than alternatives like virtual machines or bare metal servers running native applications. They also make it possible to abstract away the problems related to running the same app in different environments. Both virtual machines and containers can be useful tools for deploying scalable cloud-based applications.

### SUMMARY

In one embodiment, there is provided a computer-implemented method for compute job allocation, comprising: performing, for each executing compute job of a first group of compute jobs that are currently executing in a virtualized environment, an entity extraction process on a job description file corresponding to the executing compute job to extract a plurality of job entities; creating a plurality of clusters corresponding to the first group of compute jobs based on compute resource requirements; initializing the virtualized environment associated with each of the plurality of clusters that has parameters corresponding to the associated cluster; performing, for each queued compute job of a second group of compute jobs that are currently queued for execution, the entity extraction process on the job description file corresponding to each queued compute job of the second group of compute jobs; assigning queued compute jobs in the second group of compute jobs to a cluster from the plurality of clusters based on the compute resource requirements; and reusing a previously initialized virtualized environment associated with the cluster for execution of the queued compute jobs from the second group.

In another embodiment, there is provided an electronic computation device comprising: a processor; a memory coupled to the processor, the memory containing instructions, that when executed by the processor, cause the electronic computation device to: perform, for each executing compute job of a first group of compute jobs that are currently executing in a virtualized environment, an entity extraction process on a job description file corresponding to the executing compute job to extract a plurality of job entities; create a plurality of clusters corresponding to the first group of compute jobs based on compute resource requirements; initialize the virtualized environment associated with each of the plurality of clusters that has parameters corresponding to the associated cluster; perform, for each queued compute job of a second group of compute jobs that are currently queued for execution, the entity extraction process on the job description file corresponding to each queued compute job of the second group of compute jobs; assign queued compute jobs in the second group of compute jobs to a cluster from the plurality of clusters based on the compute resource requirements; and reuse a previously initialized virtualized environment associated with the cluster for execution of the queued compute jobs from the second group.

In yet another embodiment, there is provided a computer program product for an electronic computation device comprising a computer readable storage medium having program instructions embodied therewith, the program instructions executable by a processor to cause the electronic computation device to: perform, for each executing compute job of a first group of compute jobs that are currently executing in a virtualized environment, an entity extraction process on a job description file corresponding to the executing compute job to extract a plurality of job entities; create a plurality of clusters corresponding to the first group of compute jobs based on compute resource requirements; initialize the virtualized environment associated with each of the plurality of clusters that has parameters corresponding to the associated cluster; perform, for each queued compute job of a second group of compute jobs that are currently queued for execution, the entity extraction process on the job description file corresponding to each queued compute job of the second group of compute jobs; assign queued compute jobs in the second group of compute jobs to a cluster from the plurality of clusters based on the compute resource requirements; and reuse a previously initialized virtualized environment associated with the cluster for execution of the queued compute jobs from the second group.

### BRIEF DESCRIPTION OF THE DRAWINGS

FIG. 1 is an exemplary computing environment in accordance with disclosed embodiments.

FIG. 2 is an exemplary ecosystem in accordance with disclosed embodiments.

FIG. 3 is a flowchart showing compute job queuing in accordance with disclosed embodiments.

FIG. 4 is a flowchart showing compute job queuing in accordance with additional disclosed embodiments.

FIG. 5 is a flowchart showing compute job queuing in accordance with additional disclosed embodiments.

FIG. 6 shows a graphical example of clustering.

FIG. 7 shows a portion of an exemplary job description file.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the Figures may be omitted, or illustrated not-to-scale, for illustrative clarity.

### DETAILED DESCRIPTION

Virtual machines, and containers are useful tools for deploying scalable cloud-based applications. The configuration of virtual machines (VMs), containers, and/or other resources are dependent on the compute job being run. Machine learning (ML), and/or deep learning tasks can require intensive computing resources. Other compute-intensive processes can include data compression, video encoding, indexing, text processing, pattern recognition, and 3D animation, to name some examples. Each type of application may require a different configuration. The time required to initialize a virtualized environment can be significant. Furthermore, during the initialization, no compute jobs are being processed, and thus, the initialization process reduces the overall utilization of computer resources.

Disclosed embodiments provide techniques for compute job allocation in a virtualized computing environment. For the purposes of this disclosure, a virtualized environment refers to a computing environment that includes virtual machines and/or containers. In embodiments, a first list of compute jobs that are currently executing in a virtualized environment is obtained. For each job in the first list, a job description file is obtained. An entity extraction process is performed on the job description file to extract a plurality of job entities. Multiple clusters are created that correspond to the compute jobs in the first list. A second list of compute jobs that are currently queued for execution is obtained. For each job in the second list, a job description file is obtained. An entity extraction process is performed on the job description file to extract a plurality of job entities. Compute jobs in the second list are assigned to a cluster from the plurality of clusters; and the virtualized environment is reused, if possible, for execution of a compute job from the second list based on the assigned cluster.

By reusing a virtualized environment, the overhead of initializing a virtualized environment is reduced, which improves overall efficiency of a computer system. Disclosed embodiments examine currently running compute jobs and identify similar compute jobs that are queued. When a similar queued job is identified, it is executed on an existing virtualized environment that previously executed a similar compute job, thereby saving considerable processing cycles.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

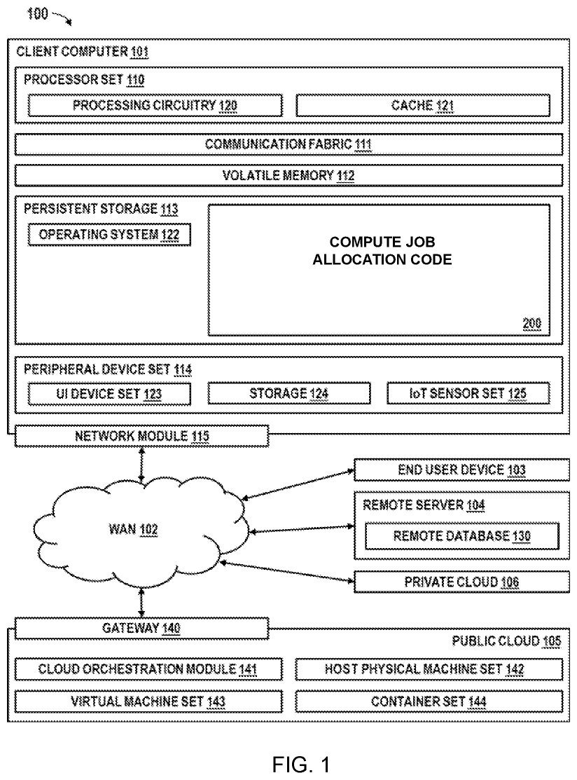

FIG. 1 shows an exemplary computing environment 100 in accordance with disclosed embodiments. Computing environment 100 contains an example of an environment for the execution of at least some of the computer code involved in performing the inventive methods, such as compute job allocation code block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

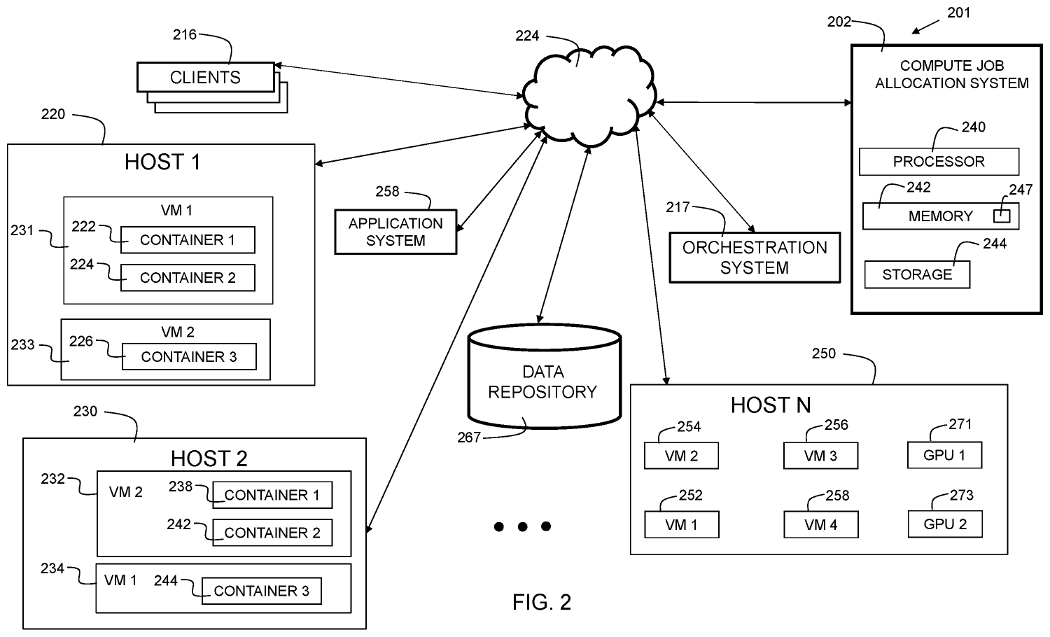

FIG. 2 is an exemplary ecosystem 201 in accordance with disclosed embodiments. Compute Job Allocation System 202 comprises a processor 240, a memory 242 coupled to the processor 240, and storage 244. System 202 is an electronic computation device. The memory 242 contains program instructions 247, that when executed by the processor 240, perform processes, techniques, and implementations of disclosed embodiments. Memory 242 may include dynamic random-access memory (DRAM), static random-access memory (SRAM), magnetic storage, and/or a read only memory such as flash, EEPROM, optical storage, or other suitable memory, and should not be construed as being a transitory signal per se. In some embodiments, storage 244 may include one or more magnetic storage devices such as hard disk drives (HDDs). Storage 244 may additionally include one or more solid state drives (SSDs). The Compute Job Allocation System 202 is configured to interact with other elements of environment 100. Compute Job Allocation System 202 is connected to network 224, which is the Internet, a wide area network, a local area network, or other suitable network.

Ecosystem 201 may include one or more client devices, indicated as 216. Client device 216 can include a laptop computer, desktop computer, tablet computer, or other suitable computing device. Client device 216 may be used to configure Compute Job Allocation System 202.

Three computers that implement a cluster of nodes are also shown connected to the network. These computers are Host 1 220, Host 2 230, and Host N 250. Host 1 220, Host 2 230, and Host N 250 are computer systems (host machines) which may include thereon one or more containers, one or more virtual machines (VMs), Graphics Processing Units (GPUs), and/or one or more natively executed applications. These host machines are typically self-sufficient, including a processor (or multiple processors), memory, and instructions thereon. Processors may contain multiple cores. Host 1 220, Host 2 230, and Host N 250 are each computers that together implement a computing cluster. While three computers are shown in FIG. 2 for implementing a computing cluster, in practice clusters can include more or fewer computers. In some cases, there can be hundreds of such computers, each running one or more VMs and/or containers.

Host 1 220 includes instances of three containers: Container 1 222, Container 2 224, and Container 3 226. A container image is a lightweight, stand-alone, executable package of software that includes everything needed to perform a role that includes one or more tasks. The container can include code, runtime libraries, system tools, system libraries, and/or configuration settings. Containerized software operates with some independence regarding the host machine/environment. Thus, containers serve to isolate software from their surroundings. Container 1 222 and container 2 224 are executing within virtual machine 231. Container 3 226 is executing within virtual machine 233.

Host 2 230 includes instances of virtual machines that are executing containers. The containers are Container 1 238, Container 2 242, and Container 3 244. The virtual machines are VM 2 232 and VM 1 234. Container 3 244 is executing within virtual machine 234. Container 1 238 and container 2 242 are executing within virtual machine 232.

Host N 250 includes instances of four virtual machines: VM 2 254, VM 1 252, VM 3 256, and VM 4 258. A virtual machine (VM) is an operating system or application environment that is installed as software, which imitates dedicated hardware. The virtual machine provides the end user with the same experience on the virtual machine as they would have on dedicated hardware.

Host N 250 further includes GPU 1, indicated as 271, and GPU 2, indicated as 273. GPUs are used in a wide range of applications, including graphics and video rendering. GPUs are also becoming more popular for use in creative production and artificial intelligence (AI).

In some embodiments, hosts can include only a single type of environment, such as containers, virtual machines, or native applications. Alternatively, a host can include a plurality of such, like in the example of Host 2. In some cases, instances of the container, virtual machine, or native application may be replicated on more than one host. This is shown in FIG. 2 as first instances of Container 1 222, Container 2 224, and Container 3 226 on Host 1 220, and second instances of each are Container 1 238, Container 2 242, and Container 3 244 on Host 2. In addition, first instances of VM 2 232 and VM 1 234 are on Host 2 230, and second instances of VM 2 254 and VM 1 252 are on Host N 250.

The computing resources shown in the example are managed by Compute Job Allocation System 202. Compute Job Allocation System 202 may interface with an orchestration system 217 that uses one or more programs to deploy, scale, and manage machines and software in the cluster as an orchestration environment. Non-limiting examples of such programs/systems are Kubernetes, Apache Hadoop, and Docker. Applications operating on such a system can include database applications such as Oracle database systems utilizing structured query language (SQL) databases. Note that the terms “KUBERNETES, ORACLE, APACHE, HADOOP, and DOCKER” may each be subject to trademark rights in various jurisdictions throughout the world. Each is used here only in reference to the products or services properly denominated by the mark to the extent that such trademark rights may exist.

In embodiments, the Compute Job Allocation System 202 may receive allocation requests for resources. Various attributes and/or metadata can be associated with the allocation request. The attributes can include, but are not limited to, number of CPUs, number of GPUs, memory amount, an affinity type for one or more levels within the physical topology and/or additional information. In embodiments, the virtualized environment can include, but are not limited to, a virtual machine (VM), container, a Graphics Processing Unit (GPU), and/or other entity. In embodiments, computing resources include at least one of: a virtual machine, a container, and a graphics processing unit (GPU).

Application system 258 can provide a compute job to be executed within a virtualized environment that is implemented by the computer cluster. The compute job can be from a wide variety of applications, including, but not limited to, machine learning, deep learning, image processing, video encoding, data encryption, pattern recognition, simulations, and so on. Application system 258 may utilize a dataset that is supplied by data repository 267. In embodiments, data repository 267 can include raw data, and/or a database, such as an SQL database, or other suitable database.

In embodiments, the virtualized environment, including configurations of VMs and/or containers, can be reused for a subsequent compute job, thereby saving the initialization time required. Furthermore, in some embodiments, a dataset can also be reused. As an example, a dataset can include customer data for the month of July. A first compute job may utilize that dataset, and then a subsequent compute job may also utilize that dataset. When that condition is present, the dataset can remain in cache/memory of the physical computing hardware (e.g., 220, 230, and/or 250), and does not need to be fetched, saving additional computing resources.

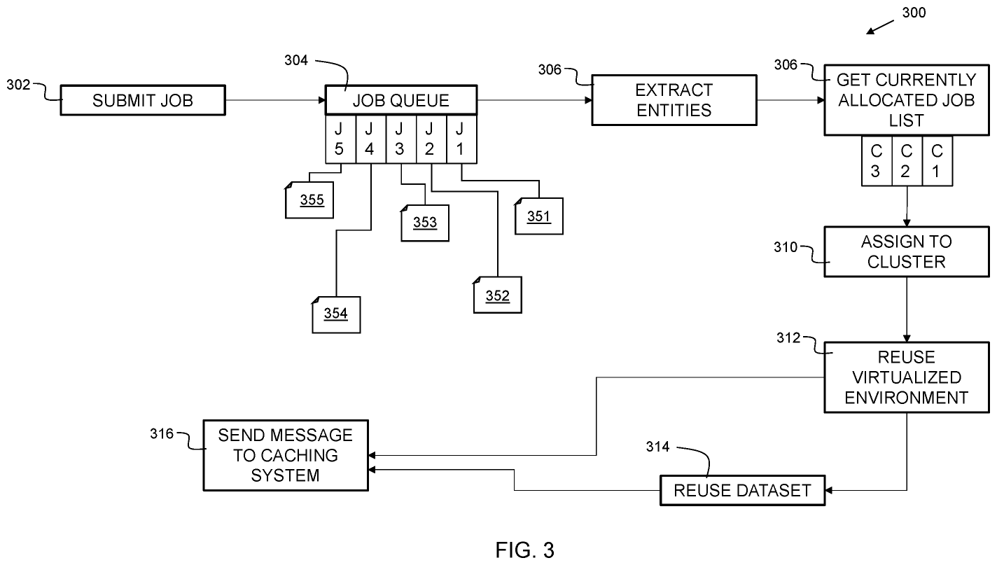

FIG. 3 is a flowchart 300 showing compute job queuing in accordance with disclosed embodiments. At 302, a compute job is submitted to a job queue 304. Job queue 304 includes five jobs, indicated as J1, J2, J3, J4, and J5, where the number following the ‘J’ indicates order of arrival in the queue. For example, compute job J1 arrived in the queue 304 before job J2, and compute job J2 arrived in the queue 304 before compute job J3, and so on. While five jobs are shown, in practice, a job queue may comprise more or fewer slots for compute jobs. Each job has a corresponding job description file. Job J1 has job description file 351, job J2 has job description file 352, job J3 has job description file 353, job J4 has job description file 354, and job J5 has job description file 355. The job description files can have a variety of formats, and may generally be unstructured. The formats for job description files can include, but are not limited to, yaml, XML, CSV, JSON, script files, or other suitable format. At 306, entities are extracted from the job description files. The entities may be extracted via natural language processing (NLP) techniques. The NLP techniques can include performing tokenization and/or other parsing of the job description files. The entities can include, but are not limited to, CPU requirements, memory requirements, GPU requirements, affinity requirements, and/or dataset requirements. At 306, a list of currently allocated jobs is obtained. This may include querying an orchestration system such as 217 of FIG. 2, to obtain a list of currently allocated and/or executing jobs. As shown in the example of FIG. 3, the list of currently allocated/executing jobs includes jobs C1, C2, and C3.

At 310, jobs are assigned to clusters. The clusters can include virtual multidimensional groupings. The dimensions can include, but are not limited to, number of CPUs, number of GPUs, memory allocations, and/or datasets. Thus, compute jobs requiring a similar number of CPUs, GPUs, memory, and/or datasets may be assigned to the same cluster. In embodiments, during system initialization, clusters may be created based on the jobs from the currently allocated job list obtained at 306. Once the clusters are created, incoming jobs from the job queue 304 may be assigned to the existing clusters using similar criteria. A job from the job queue is assigned to a cluster corresponding to a currently executing job, if its requirements are similar (e.g., CPU requirements, etc.). Once the currently executing job completes, the job from the job queue that is assigned to the same cluster as the job which just completed is allocated to the virtualized environment of the job that just completed without needing to recreate the virtualized environment. As an example, if job J1 has similar CPU, GPU, memory, and dataset requirements as currently executing job C3, then job J1 is assigned to the same cluster as job C3. When job C3 completes, job J1 can be assigned to the same virtualized environment that was used for job C3, without having to recreate the virtualized environment. This saves precious computing resources, as processor cycles to not need to be used to recreate virtual machines and/or containers. In some cases, the input dataset can also be reused, further saving processor cycles.

At 312, a virtualized environment is reused, based on the cluster assignments of the jobs queued in job queue 304, and the cluster assignments of the jobs in the currently allocated job list 306. Optionally, the flow continues to 314 where a dataset is also reused, further saving computing resources such as processor cycles and/or network bandwidth. The flow continues with sending a message to a caching system 316 of the orchestration system to preserve the virtualized environment, rather than deleting it upon completion of a currently executing job.

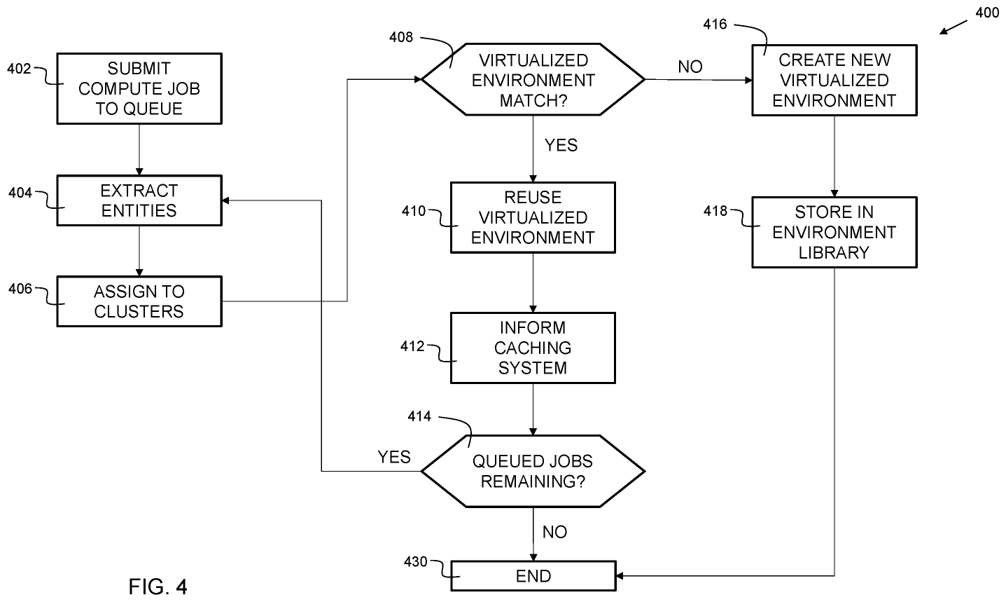

FIG. 4 is a flowchart 400 showing compute job queuing in accordance with additional disclosed embodiments. At 402, a compute job is submitted to a job queue. The compute job can be a machine learning job, a deep learning job, a data analysis job, a data encryption job, a data encoding job, or other type of computational task. At 404, entities are extracted. In embodiments, this includes performing a natural language processing process on job description files associated with queued compute jobs. In addition to natural language processing (NLP), embodiments may perform tokenization and/or other parsing of the job description files. The entities extracted may include CPU requirements, GPU requirements, memory requirements, and/or dataset requirements. The entities may further include semantic priority information. The semantic priority information can include the name of an application, an imposed deadline, an assigned priority, and/or other relevant information. The semantic priority information can be used to enable out-of-order execution of compute jobs in the job queue. As an example, referring again to FIG. 3, job J1 may be the next job in the queue to be assigned, but in a situation where job J3 has a higher semantic priority than the other queued jobs, job J3 can be moved to a different location in the job queue, such that job J3 is removed from the job queue before jobs J1 and J2, and assigned to a virtualized environment ahead of jobs J1 and J2 based on the semantic priority.

At 406, queued jobs are assigned to clusters. The queued jobs may be assigned to existing clusters, or in some embodiments, a new cluster may be created for a queued job if it does not fit into any existing clusters. A cluster may be based on one or more computational requirements. As an example, a cluster can be based on CPU and GPU requirements. Clusters can be based on requirement ranges. For example, a first cluster can include compute jobs that require between one to three CPUs and one to three GPUs, and a second cluster can include compute jobs that require between four to eight CPUs, and four to eight GPUs. If an incoming compute job requires five CPUs and five GPUs, it is assigned to the second cluster, whereas an incoming compute job that requires three CPUs and one GPU is assigned to the first cluster. This clustering technique can be used with more than two dimensions in some embodiments.

At 408, a check is made to determine if there is a virtualized environment match. This is performed using clustering techniques. The clustering techniques can include, but are not limited to, K-means clustering, affinity propagation, hierarchical clustering, mean clustering, and/or other suitable clustering techniques. Each virtualized environment is associated with a currently allocated/executing job, which is in turn assigned to a cluster. If a queued job is also assigned to that cluster, then it is deemed to be compatible with, and hence a ‘match’ for that virtualized environment. Thus, if yes at 408, the process continues to 410 where the virtualized environment is reused for another job, thereby saving the time and energy required to recreate the virtualized environment. Thus, new compute jobs can be executed in the existing virtualized environment without the need to instantiate a new virtualized environment, thereby saving considerable computing resources and time. The process then continues to 412 where the caching system is informed to retain the virtualized environment and/or dataset. In embodiments, this is accomplished via application programming interface (API) calls to the orchestration system 217. At 414 a check is made to determine if any queued jobs are remaining, if yes at 414, the process continues back to 404 and repeats. If no at 414 then the process ends at 430. In some embodiments, at 430, the virtualized environments may be deleted when no more compute jobs are queued. In some embodiments, if a virtualized environment has been idle (has had no compute jobs assigned to it) for a predetermined amount of time (e.g., 30 to 60 minutes), the virtualized environment is deleted.

If no at 408, then the process continues to 416 where a new virtualized environment is created. The creating a new virtualized environment can include creating VMs, containers, and/or fetching datasets. The creating of a virtual machine can include specifying the amount of memory, the number of processors (physical CPU cores), the CPU priority of the virtual machine, the server pool on which to create the virtual machine, the operating system to use for the virtual machine, and/or other options. Each of the aforementioned options may be used as a dimension for the clustering assignments that occur at 406.

The creating of a new container can include networking configurations for the container, the hostname of the container, the memory allocated to the container, swap memory allocated to the container, the number of CPUs allocated to the container, and/or other options. Each of the aforementioned options may be used as a dimension for the clustering assignments that occur at 406.

At 418, the new virtualized environment configuration is stored in an environment library. The environment library is a repository for configuration information, and may further include additional metadata such as the name of the application (compute job) that resulted in the creation of the virtualized environment, the date of creation, and the number of times the virtualized environment is requested. The data stored in the environment library can be used to further improve overall computer system performance by using this data to determine when to remove a virtualized environment. As an example, virtualized environments that are frequently requested may be allowed to remain active after a job completion for a period of time, in case a new job is submitted to the queue 402 that could also use that virtualized environment. Conversely, if a virtualized environment is rarely reused, it may be removed upon completion of the compute job that allocated it, to free up the physical computing resources (such as shown in FIG. 2) to enable a new virtualized environment to be created. In this way, disclosed embodiments improve the technical field of virtualized environment computing.

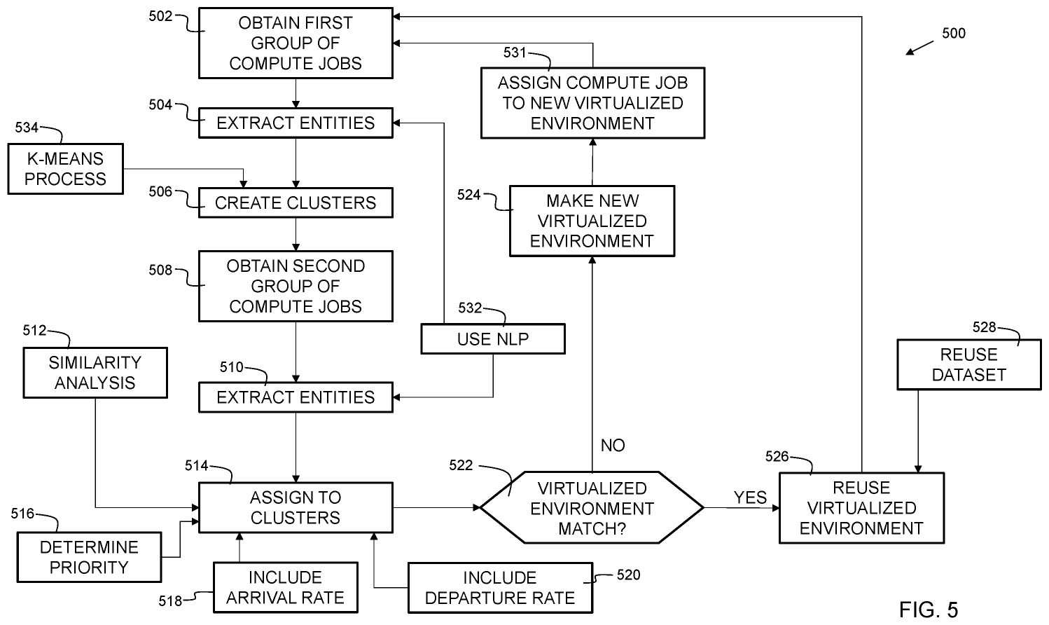

FIG. 5 is a flowchart 500 showing compute job queuing in accordance with additional disclosed embodiments. At 502, a first group (list) of compute jobs is obtained. The jobs in the first list are jobs that are currently executing in a virtualized environment. The list may be obtained by querying an orchestration system such as 217 of FIG. 2 via APIs, or other suitable techniques.

At 504 entities are extracted from job description files associated with each job in the list obtained at 502. The entities can include virtualized environment parameters such as memory requirements, number of CPUs, number of GPUs (graphics processing units), datasets, network configurations, and/or other parameters. The entities can also include priority information, as well as other metadata, such as the name of the compute job, due date, requestor, etc. In embodiments, the entities are extracted using a natural language processing (NLP) process 532. The NLP process can be based on machine learning. The NLP process can include tokenizing the job description file, identifying delimiters, parts of speech, numerical values, and/or other fields within the job description file.

At 506, clusters are created. The clusters are mathematical representations of virtualized environments. In embodiments, clusters can have a one-to-one relationship with virtualized environments. The clusters can be created using a variety of techniques, including a K-means clustering process 534. The clustering can be based on multiple dimensions. Each dimension can represent a parameter that is used in defining a virtualized environment. The dimensions can include, but are not limited to, number of CPUs, number of GPUs, memory requirements, datasets, affinity level, affinity type, and/or other parameters. The affinity level can include a room, rack, or server level, as an example. The affinity type can include pack, spread, or other suitable value. Thus, as an example, a pack affinity at the rack level implies that it is desired to run all VMs/containers within the same physical computer rack. The clustering can be based on ranges of parameters. As an example, a cluster can be based on a memory requirement range, a range of CPUs, and so on. Compute job requests matching all the criteria of a cluster, can be assigned to that cluster.

At 508, a second group (list) of compute jobs is obtained. The second list includes compute jobs that are currently queued for execution. In embodiments, the obtaining of the second list can include iterating through records in a job queue such as shown at 304 in FIG. 3. At 510, the entities are extracted from job description files associated with each job in the list obtained at 508. The entities can include virtualized environment parameters such as memory requirements, number of CPUs, number of GPUs (graphics processing units), datasets, network configurations, and/or other parameters. The entities can also include priority information, as well as other metadata, such as the name of the compute job, due date, requestor, etc. In embodiments, the entities are extracted using a natural language processing (NLP) process 532. The NLP process can be based on machine learning. The NLP process can include tokenizing the job description file, identifying delimiters, parts of speech, numerical values, and/or other fields within the job description file.

At 514, the entities are assigned to clusters. The clustering techniques can include, but are not limited to, K-means clustering, affinity propagation, hierarchical clustering, density-based clustering (DBSCAN), mean clustering, and/or other suitable clustering techniques. In embodiments, the clustering may further include performing a similarity analysis 512. In embodiments, the similarity analysis can include computing a similarity matrix, performing a cosine similarity computation process, computing a Euclidean distance matrix, generating a single link dendrogram, complete link dendrogram, group average dendrogram, or other suitable technique.

The assigning of compute jobs to clusters and/or virtualized environments can also be based on an arrival rate 518 of compute jobs into the queue, and/or a departure rate 520 of compute jobs exiting the queue. The assigning of compute jobs to clusters and/or virtualized environments can also be based on determination of a priority 516. The priority can be derived from entities and/or metadata extracted from job description files. The process continues to 522 where a check is made to see if the virtualized environment required or requested by a queued compute job matches a virtualized environment that is currently deployed to physical hardware, such as shown in FIG. 2. In embodiments, a match may be determined to exist if the virtualized environment of the queued job is assigned to the same cluster as a currently allocated/executing compute job. If yes at 522, then the process continues to 526 where the virtualized environment is reused. Optionally, the dataset is reused as well at 528. If no at 522, then the process continues to 524 where a new virtualized environment is created, and the compute job is then allocated to that virtualized environment at 531. The process shown in flowchart 500 can repeat as new compute jobs continue to enter the queue.

In embodiments, the virtualized environment further includes a dataset, and reusing the virtualized environment includes reusing the dataset. In embodiments, performing the entity extraction process comprises performing a natural language processing (NLP) process. In embodiments, creating a plurality of clusters is performed using a K-means process. In embodiments, assigning compute jobs to clusters includes performing a similarity analysis. In embodiments, assigning compute jobs in the second list to a cluster is based on an arrival rate of compute jobs. In embodiments, assigning compute jobs in the second list to a cluster is based on a departure rate of compute jobs. Embodiments can include determining a schedule priority of a compute job in the second list based on the NLP process; and moving the compute job to a different location within a job queue based on the schedule priority. In some embodiments, one or more of the actions shown in flowchart 500 may be performed in a different order, performed concurrently, or omitted.

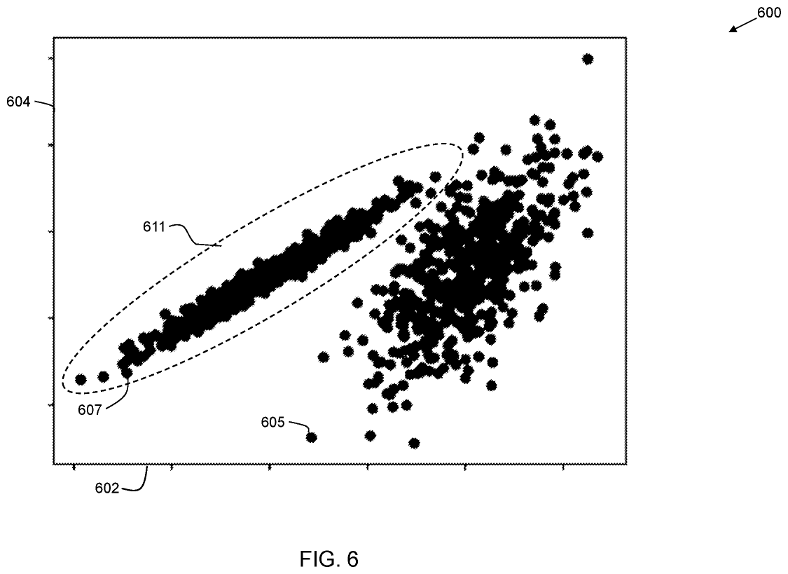

FIG. 6 shows a graphical example of clustering. Graph 600 shows a plot of multiple datapoints, indicated generally as 605. Graph 600 is two-dimensional, and includes X-axis 602, and Y-axis 604. The X-axis and Y-axis can each represent different parameters. As an example, the X-axis can be a number of GPUs and the Y-axis can be a number of CPUs. In some embodiments, the units of the graph may be dimensionless, and/or normalized as necessary for graphing the datapoints. Datapoints that are within a given region, such as indicated at 611, are deemed to be within a cluster. Thus, datapoint 607 is deemed to be in the cluster indicated at 611, while datapoint 605 is not part of the cluster indicated at 611. In embodiments, each datapoint represents a queued compute job. In embodiments, the cluster is associated with a virtualized environment. When the virtualized environment associated with cluster 611 is allocated (initialized and deployed to physical hardware), the compute jobs associated with cluster 611 can reuse the virtualized environment, thereby saving the processing cycles, network bandwidth, and time required to recreate the virtualized environment. While only one cluster is shown in FIG. 6, embodiments may include multiple clusters. In embodiments, a heuristic, such as the elbow method may be used for determining the number of clusters in the dataset.

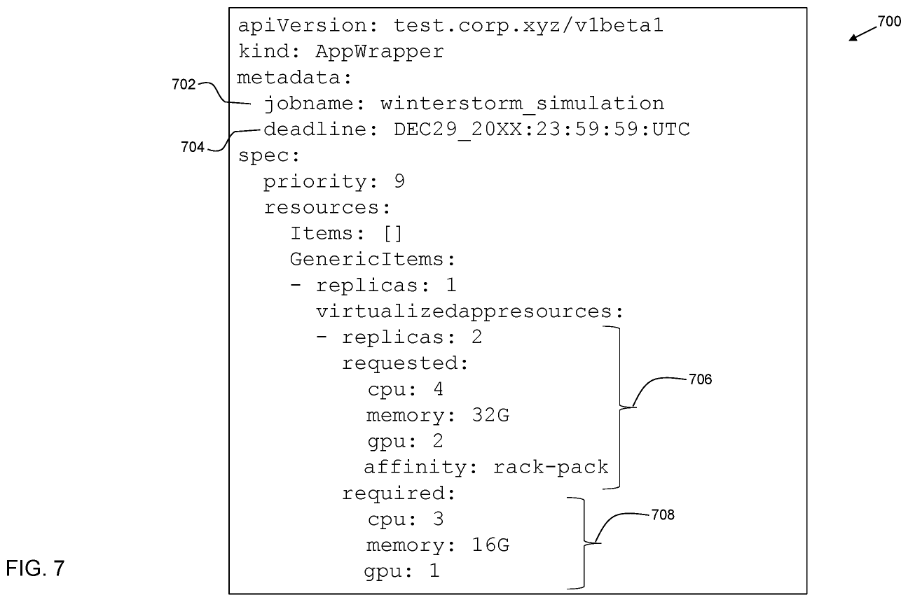

FIG. 7 shows a portion of an exemplary job description file. File 700 is written in a yaml format. Other formats, such as XML, JSON, and/or unstructured formats may be used in some embodiments. The NLP process can perform tokenization, identification of speech parts, and other analysis in order to parse the job description file. In the example shown in FIG. 7, file 700 includes a ‘jobname’ field 702 that indicates a name for the compute job. At 704 there is a ‘deadline’ field that indicates a deadline for the compute job execution to be started. At 706 there is a group of preferred parameters, that include CPU, memory, GPU, and affinity. These are merely exemplary, and more, fewer, and/or different parameters may be included in the job description file in some embodiments. At 708 there is a group of required parameters. The required parameters in this example include CPU, memory, and GPU. In embodiments, extracting a plurality of job entities comprises extracting entities selected from the group consisting of CPU, GPU, and memory. These extracted entities may be used to define a cluster, where each entity is a dimension of the cluster. These are merely exemplary, and more, fewer, and/or different parameters may be included in the job description file in some embodiments. In embodiments, to be assigned to a cluster, a two-part process is performed in which the required parameters 708 are first checked and satisfied. If the required parameters are matchable to a cluster, then a second search is made to determine if a different cluster more closely matches the requested parameters 706. In some embodiments, if a first cluster has a number of queued jobs waiting to be allocated to it, disclosed embodiments may search for an alternate cluster that has less jobs queued for it. The alternate cluster satisfies the required compute job parameters 708, but might not necessarily satisfy the requested compute job parameters 706. As an example, if a first cluster is associated with a first virtualized environment that meets the required parameters, and a second cluster is associated with a second virtualized environment that is more capable, and satisfies the requested compute job parameters, then, if both virtualized environments are available, the compute job may be assigned to the second virtualized environment. However, if, for example, there are ten compute jobs queued for the second virtualized environment and only two compute jobs queued for the first virtualized environment, the compute job may be allocated to the first virtualized environment. As shown by this example, in disclosed embodiments, effective load balancing can be accomplished by further exploiting virtualized environments that are currently allocated. Embodiments can include performing natural language processing on a yaml file to extract compute job entities.

As can now be appreciated, disclosed embodiments provide improvements in the utilization of computer resources. Virtualized environments, which can include virtual machines and/or containers, require resources to be created and initialized. These resources can include electricity, processing clock cycles, network bandwidth, and more. Queued job clusters and running job clusters are compared to get the ideal placement of the next compute job. Disclosed embodiments further utilize NLP to discover entities from user-specified job description files. By strategically determining when a virtualized environment can be used, these resources are saved. Thus, disclosed embodiments can reuse the scheduling cycle of the previous job by holistically comparing running jobs as well as queued jobs for images or datasets using clustering.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for compute job allocation, comprising:
performing, for each executing compute job of a first group of compute jobs that are currently executing in a virtualized environment, an entity extraction process on a job description file corresponding to the executing compute job to extract a plurality of job entities;
creating a plurality of clusters corresponding to the first group of compute jobs based on compute resource requirements;
initializing the virtualized environment associated with each of the plurality of clusters that has parameters corresponding to the associated cluster;
performing, for each queued compute job of a second group of compute jobs that are currently queued for execution, the entity extraction process on the job description file corresponding to each queued compute job of the second group of compute jobs;
assigning queued compute jobs in the second group of compute jobs to a cluster from the plurality of clusters based on the compute resource requirements; and
reusing a previously initialized virtualized environment associated with the cluster for execution of the queued compute jobs from the second group.

2. The method of claim 1, wherein the virtualized environment further includes a dataset, and wherein reusing the virtualized environment includes reusing the dataset.

3. The method of claim 1, wherein performing the entity extraction process comprises performing a natural language processing (NLP) process based on machine learning.

4. The method of claim 1, wherein creating the plurality of clusters is performed using a technique selected from the group consisting of K-means process, affinity propagation, hierarchical clustering, and mean clustering.

5. The method of claim 1, wherein extracting a plurality of job entities comprises extracting entities selected from the group consisting of CPU, GPU, and memory.

6. The method of claim 1, wherein the assigning includes performing a similarity analysis selected from the group consisting of cosine similarity computation process, Euclidean distance matrix, single link dendrogram, complete link dendrogram, and group average dendrogram.

7. The method of claim 1, wherein assigning compute jobs in the second group to the cluster is based on an arrival rate of compute jobs.

8. The method of claim 1, wherein assigning compute jobs in the second group to the cluster is based on a departure rate of compute jobs.

9. The method of claim 3, further comprising:
determining a schedule priority of each compute job in the second group based on the NLP process; and
moving at least one compute job in the second group to a different location within a job queue based on the schedule priority.

10. An electronic computation device comprising:
a processor;
a memory coupled to the processor, the memory containing instructions, that when executed by the processor, cause the electronic computation device to:
perform, for each executing compute job of a first group of compute jobs that are currently executing in a virtualized environment, an entity extraction process on a job description file corresponding to the executing compute job to extract a plurality of job entities;
create a plurality of clusters corresponding to the first group of compute jobs based on compute resource requirements;
initialize the virtualized environment associated with each of the plurality of clusters that has parameters corresponding to the associated cluster;
perform, for each queued compute job of a second group of compute jobs that are currently queued for execution, the entity extraction process on the job description file corresponding to each queued compute job of the second group of compute jobs;
assign queued compute jobs in the second group of compute jobs to a cluster from the plurality of clusters based on the compute resource requirements; and
reuse a previously initialized virtualized environment associated with the cluster for execution of the queued compute jobs from the second group.

11. The electronic computation device of claim 10, wherein the memory further comprises instructions, that when executed by the processor, cause the electronic computation device to reuse a dataset within the virtualized environment.

12. The electronic computation device of claim 10, wherein the memory further comprises instructions, that when executed by the processor, cause the electronic computation device to perform the entity extraction process utilizing a natural language processing (NLP) process based on machine learning.

13. The electronic computation device of claim 10, wherein the memory further comprises instructions, that when executed by the processor, cause the electronic computation device to create the plurality of clusters using a process selected from the group consisting of K-means process, affinity propagation, hierarchical clustering, and mean clustering.

14. The electronic computation device of claim 10, wherein the memory further comprises instructions, that when executed by the processor, cause the electronic computation device to perform the assigning of the compute jobs by a process that includes a similarity analysis selected from the group consisting of cosine similarity computation process, Euclidean distance matrix, single link dendrogram, complete link dendrogram, and group average dendrogram.

15. A computer program product for an electronic computation device comprising a computer readable storage medium having program instructions embodied therewith, the program instructions executable by a processor to cause the electronic computation device to:
perform, for each executing compute job of a first group of compute jobs that are currently executing in a virtualized environment, an entity extraction process on a job description file corresponding to the executing compute job to extract a plurality of job entities;
create a plurality of clusters corresponding to the first group of compute jobs based on compute resource requirements;
initialize the virtualized environment associated with each of the plurality of clusters that has parameters corresponding to the associated cluster;
perform, for each queued compute job of a second group of compute jobs that are currently queued for execution, the entity extraction process on the job description file corresponding to each queued compute job of the second group of compute jobs;
assign queued compute jobs in the second group of compute jobs to a cluster from the plurality of clusters based on the compute resource requirements; and
reuse a previously initialized virtualized environment associated with the cluster for execution of the queued compute jobs from the second group.

16. The computer program product of claim 15, wherein the computer readable storage medium further comprises program instructions, that when executed by the processor, cause the electronic computation device to reuse a dataset within the virtualized environment.

17. The computer program product of claim 15, wherein the computer readable storage medium further comprises program instructions, that when executed by the processor, cause the electronic computation device to perform the entity extraction process utilizing a natural language processing (NLP) process based on machine learning.

18. The computer program product of claim 15, wherein the computer readable storage medium further comprises program instructions, that when executed by the processor, cause the electronic computation device to create the plurality of clusters using a technique selected from the group consisting of K-means process, affinity propagation, hierarchical clustering, and mean clustering.

19. The computer program product of claim 15, wherein the computer readable storage medium further comprises program instructions, that when executed by the processor, cause the electronic computation device to extract a plurality of job entities selected from the group consisting of CPU, GPU, and memory.

20. The computer program product of claim 15, wherein the computer readable storage medium further comprises program instructions, that when executed by the processor, cause the electronic computation device to assign the compute jobs by a process that includes a similarity analysis selected from the group consisting of cosine similarity computation process, Euclidean distance matrix, single link dendrogram, complete link dendrogram, and group average dendrogram.
